(19) United States
(12) Patent Application Publication
(10) Pub. No.: US 2015/0194133 A1
(43) Pub. Date: Jul. 9, 2015

(54) PORTABLE ELECTRONIC DEVICE WITH PROJECTING FUNCTION AND PROJECTING METHOD THEREOF

(71) Applicant: LITE-ON IT CORPORATION, Taipei (TW)

(72) Inventors: Chi-Hung Lin, Hsinchu (TW); Chun-Lai Hsiao, Hsinchu (TW)

(73) Assignee: LITE-ON IT CORPORATION, Taipei (TW)

(21) Appl. No.: 14/196,115

(22) Filed: Mar. 4, 2014

(30) Foreign Application Priority Data
Jan. 6, 2014 (CN) 201410004682.3

(51) Int. Cl. G09G 5/36; G06T 3/00; G06T 5/00; G09G 5/373; G09G 5/38

(52) U.S. Cl. CPC G09G 5/363; G09G 5/373; G09G 5/38; G06T 5/006; G06T 3/0006; G09G 2320/08; G09G 2340/0492; G06T 2210/32

(57) ABSTRACT

A portable electronic device with a projecting function and a projecting method are provided. The portable electronic device includes a posture sensor, a projection lens, and a controller. The posture sensor is used for detecting the orientation information of the portable electronic device. The projection lens is used for projecting a source image as a projection image. The controller is electrically connected with the posture sensor and the projection lens for judging an orientation status of the portable electronic device according to the orientation information. According to the orientation status of the portable electronic device, an approach of producing the projection image is correspondingly adjusted.

This application claims the benefit of People's Republic of China Patent Application No. 201410004682.3, filed Jan. 6, 2014, the subject matter of which is incorporated herein by reference.

### FIELD OF THE INVENTION

The present invention relates to a portable electronic device and a projecting method thereof, and more particularly to a portable electronic device capable of producing an adjustable projection image and a projecting method thereof.

### BACKGROUND OF THE INVENTION

With increasing development of science and technology, a variety of electronic devices are developed toward small size, light weightiness and easy portability. Consequently, various portable electronic devices with video functions or other applications are produced by the manufacturers. However, the small-sized portable electronic device is not equipped with a large-size screen. A pico projector is thus developed. The pico projector may be installed in the small-sized portable electronic device to achieve a function of large-area display. The pico projector may be integrated into a smart phone, a tablet computer or any other appropriate portable electronic device.

FIG. 1 schematically illustrates a portable electronic device with a projecting function. In FIG. 1, an x-y-z coordinate system is used to specify the placement of the portable electronic device 10.

As shown in FIG. 1, the portable electronic device 10 is placed on an x-y plane. The length side of the portable electronic device 10 is in parallel with the x-axis. The width side of the portable electronic device 10 is in parallel with the y-axis. Moreover, the display screen of the portable electronic device 10 faces the positive z-axis direction. That is, the portable electronic device 10 has a face-up orientation. For illustration, the backside (e.g. a rear cover) of the portable electronic device 10 is indicated as screentones.

In FIG. 1, an image beam from a lens 107 is projected as a projection image 14 in the x-axis direction. The image beam is indicated as dotted lines. The projection image 14 is formed on a projection surface (not shown), which is located at a position of the positive x-axis.

FIG. 2 schematically illustrates a projection image obtained by the portable electronic device in the status of FIG. 1. As shown in FIG. 2, the projection image 14 contains an image of a house and an image of a tree.

FIG. 3 schematically illustrates the portable electronic device of FIG. 1, in which the portable electronic device is placed upside down. In FIG. 3, the x-y-z coordinate system is also used to specify the placement of the portable electronic device 10.

After the portable electronic device 10 is inverted, the backside (e.g. a rear cover) of the portable electronic device 10 faces the positive z-axis direction. That is, the portable electronic device 10 has a face-down orientation. Under this circumstance, an image beam from the lens 107 is projected as a projection image 16 in the x-axis direction. The image beam is indicated as dotted lines. The projection image 16 is formed on the projection surface (not shown), which is located at a position of the positive x-axis.

FIG. 4 schematically illustrates a projection image obtained by the portable electronic device in the status of FIG. 3. In comparison with the projection image 14 of FIG. 2, the image of the house and the image of the tree contained in projection image 16 of FIG. 4 are both rotated by 180 degrees. In other words, if the placement of the portable electronic device 10 is changed, the projection image is correspondingly changed.

From the above discussions, the projection image produced by the conventional portable electronic device is easily influenced by the orientation status. In other words, the projection image may be erroneously displayed.

### SUMMARY OF THE INVENTION

The present invention relates to a portable electronic device and a projecting method thereof, and more particularly to a portable electronic device capable with a projecting function and a projecting method thereof.

An embodiment of the present invention provides a portable electronic device with a projecting function. The portable electronic device includes a posture sensor, a projection lens, and a controller. The posture sensor is used for detecting the orientation information of the portable electronic device. The projection lens is used for projecting a source image as a projection image. The controller is electrically connected with the posture sensor and the projection lens. The controller judges an orientation status of the portable electronic device according to the orientation information. According to the orientation status of the portable electronic device, an approach of producing the projection image is correspondingly adjusted.

Another embodiment of the present invention provides a projecting method for a portable electronic device. The projecting method includes the following steps. Firstly, the orientation information of the portable electronic device is detected. Then, an orientation status of the portable electronic device is judged according to the orientation information. Then, a source image is projected as a projection image. An approach of producing the projection image is correspondingly adjusted according to the orientation status of the portable electronic device.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) schematically illustrates a portable electronic device with a projecting function;

FIG. 2 (prior art) schematically illustrates a projection image obtained by the portable electronic device in the status of FIG. 1;

FIG. 3 (prior art) schematically illustrates the portable electronic device of FIG. 1, in which the portable electronic device is placed upside down;

FIG. 4 (prior art) schematically illustrates a projection image obtained by the portable electronic device in the status of FIG. 3;

FIG. 5 is a schematic functional block diagram illustrating a portable electronic device according to an embodiment of the present invention;

FIG. 6A schematically illustrates the portable electronic device in a default orientation status;

FIG. 6B schematically illustrates the portable electronic device in an inverted orientation status;

FIG. 7A schematically illustrating a projection image obtained by the portable electronic device in the inverted orientation status of FIG. 6B, which the inverted displaying function is disabled;

FIG. 7B schematically illustrating a projection image obtained by the portable electronic device in the inverted orientation status of FIG. 6B, which the inverted displaying function is enabled;

FIG. 8 is a flowchart illustrating a projecting method according to an embodiment of the present invention; and

FIG. 9 is a flowchart illustrating the step S5 of the projecting method according to the embodiment of the present invention.

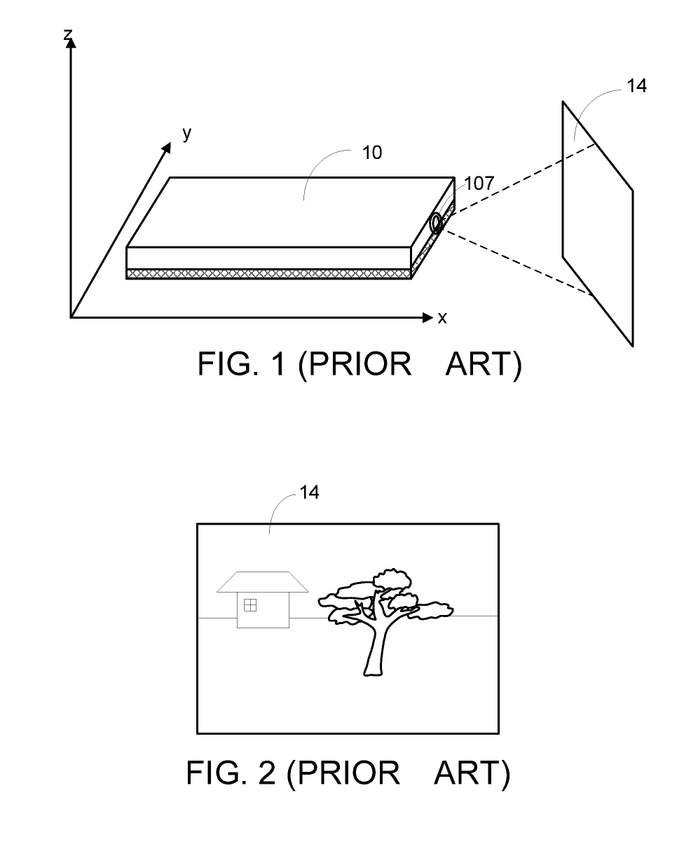

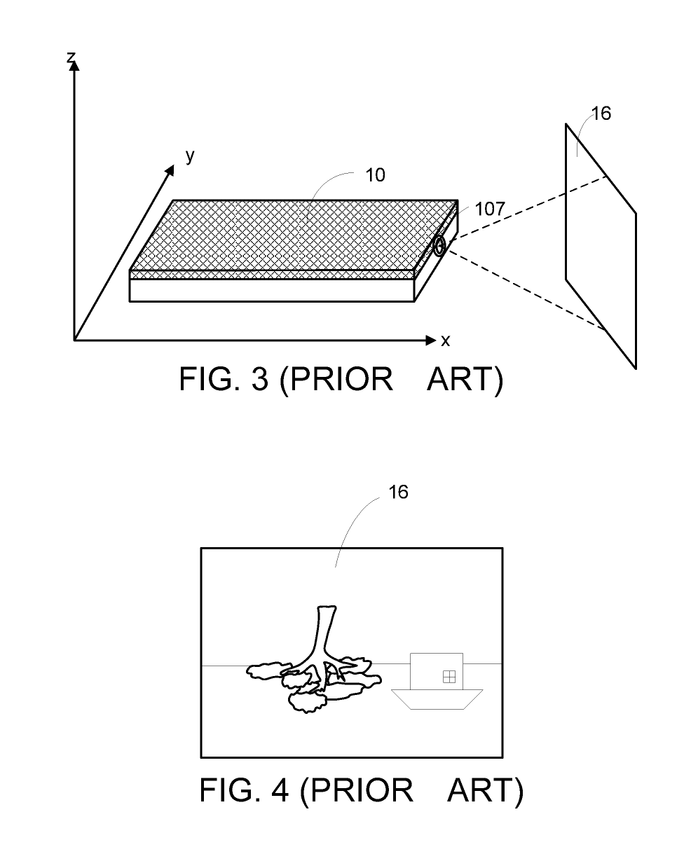

### DETAILED DESCRIPTION OF PREFERRED EMBODIMENTS

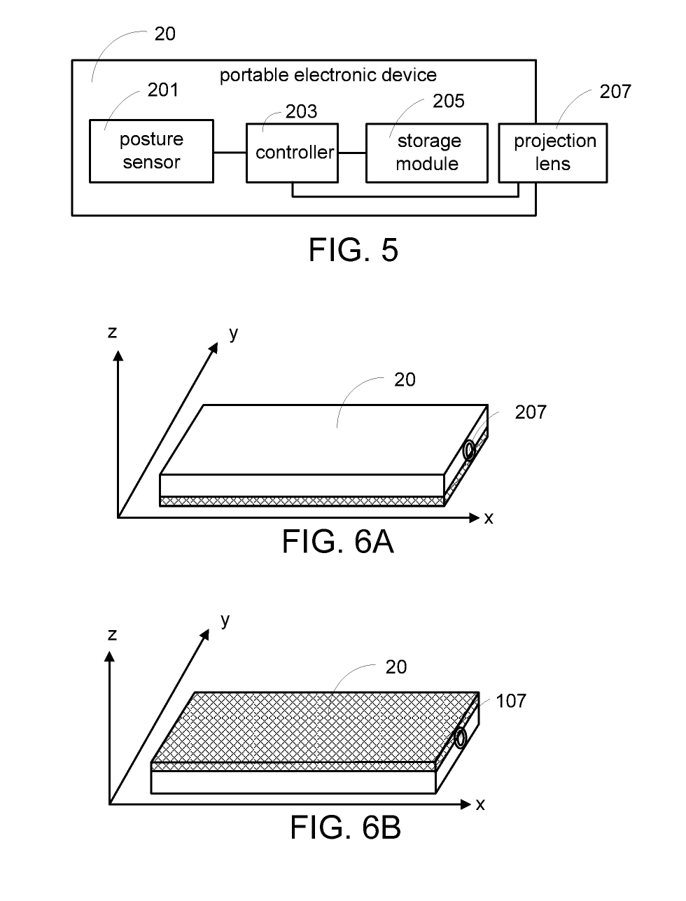

FIG. 5 is a schematic functional block diagram illustrating a portable electronic device according to an embodiment of the present invention. As shown in FIG. 5, the portable electronic device 20 includes a posture sensor 201, a controller 203, a storage module 205, and a projection lens 207. The controller 203 is electrically connected to the posture sensor 201, the storage module 205 and the projection lens 207.

The storage module 205 is used for storing a source image. The posture sensor 201 is used for detecting an orientation information of the portable electronic device 20. An example of the posture sensor 201 includes but is not limited to a gyroscope. According to the orientation information, the controller 203 can realize an orientation status of the portable electronic device 20, thereby determining the approach of how the projection lens 207 produces a projection image. The projection lens 207 is used for projecting the source image (or an image beam) as a projection image (not shown) on a projection surface (not shown). An example of the projection surface is a projection screen or a wall surface.

In addition, the portable electronic device 20 is placed on a plane. For example, the portable electronic device 20 is placed on the plane through a supporting device (not shown) or the user's hand.

FIG. 6A schematically illustrates the portable electronic device in a default orientation status. For illustration, the backside (e.g. a rear cover) of the portable electronic device 20 is indicated as screentones. The posture sensor 201, the controller 203 and the storage module 205 are disposed within the casing of the portable electronic device 20.

In the default orientation status, the portable electronic device 20 has a face-up orientation. Under this circumstance, the projection image can be normally displayed on the projection surface. Under control of the controller 203, the source image is enlarged by the projection lens 207 and projected on the projection surface.

As shown in FIG. 6A, the portable electronic device 20 is horizontally placed on an x-y plane. The length side of the portable electronic device 20 is in parallel with the x-axis. The width side of the portable electronic device 20 is in parallel with the y-axis. Moreover, the display screen of the portable electronic device 20 faces the positive z-axis direction.

The portable electronic device 20 may be rotated about the x-axis, the y-axis or the z-axis. In case that the portable electronic device 20 is rotated at any angle with respect to the z-axis, the display screen of the portable electronic device 20 still faces the positive z-axis direction and the backside of the portable electronic device 20 is still contacted with the x-y plane. Under this circumstance, the projection image is not upside down. In other words, after the source image is enlarged by the projection lens 207, the projection image is directly formed on the projection surface.

In case that the portable electronic device 20 is rotated about the x-axis by 180 degrees, the portable electronic device 20 faces down (see FIG. 6B), and the portable electronic device 20 is placed in an inverted orientation status. Alternatively, in case that the portable electronic device 20 is rotated about the y-axis by 180 degrees, the display screen of the portable electronic device 20 faces the negative z-axis direction.

When the display screen of the portable electronic device 20 faces the negative z-axis direction, the portable electronic device 20 is also placed in the inverted orientation status.

FIG. 6B schematically illustrates the portable electronic device in an inverted orientation status. In the inverted orientation status, the portable electronic device 20 has a face-down orientation. As mentioned above, the orientation information of the portable electronic device 20 is continuously detected by the posture sensor 201. Alternatively, in some other embodiments, the posture sensor 201 is turned on after the projecting function of the portable electronic device 20 is enabled, and the posture sensor 201 is turned off after the projecting function of the portable electronic device 20 is disabled. After the orientation information is transmitted to the controller 203, the controller 203 judges whether the portable electronic device 20 is placed in the inverted orientation status.

In case that the portable electronic device 20 is placed in the inverted orientation status, the controller 20 further determines an approach of displaying the projection image through an inverted displaying function. According to the settings of an application software, the inverted displaying function may be selectively enabled or disabled.

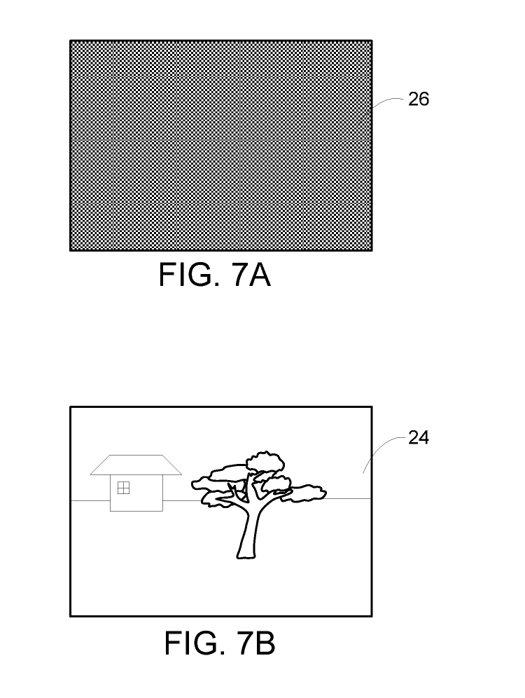

FIG. 7A schematically illustrating a projection image obtained by the portable electronic device in the inverted orientation status of FIG. 6B, which the inverted displaying function is disabled. Since the inverted displaying function is disabled, the projection image is not projected by the projection lens 207. Under this circumstance, a completely dark image 26 is formed on the projection surface.

FIG. 7B schematically illustrating a projection image obtained by the portable electronic device in the inverted orientation status of FIG. 6B, which the inverted displaying function is enabled. In case that the portable electronic device in the inverted orientation status and the inverted displaying function is enabled, the source image is rotated by 180 degrees and then enlarged and projected on the projection surface. Consequently, the projection image 24 shown on the projection surface is no longer upside down.

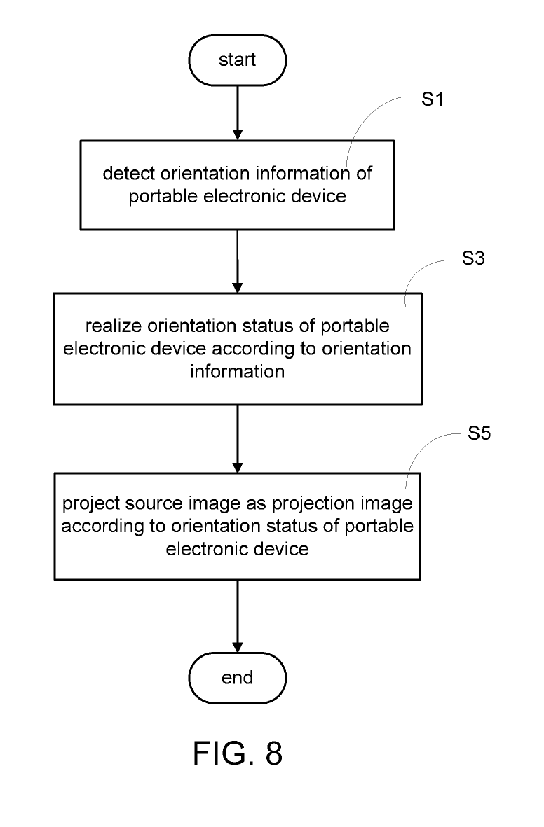

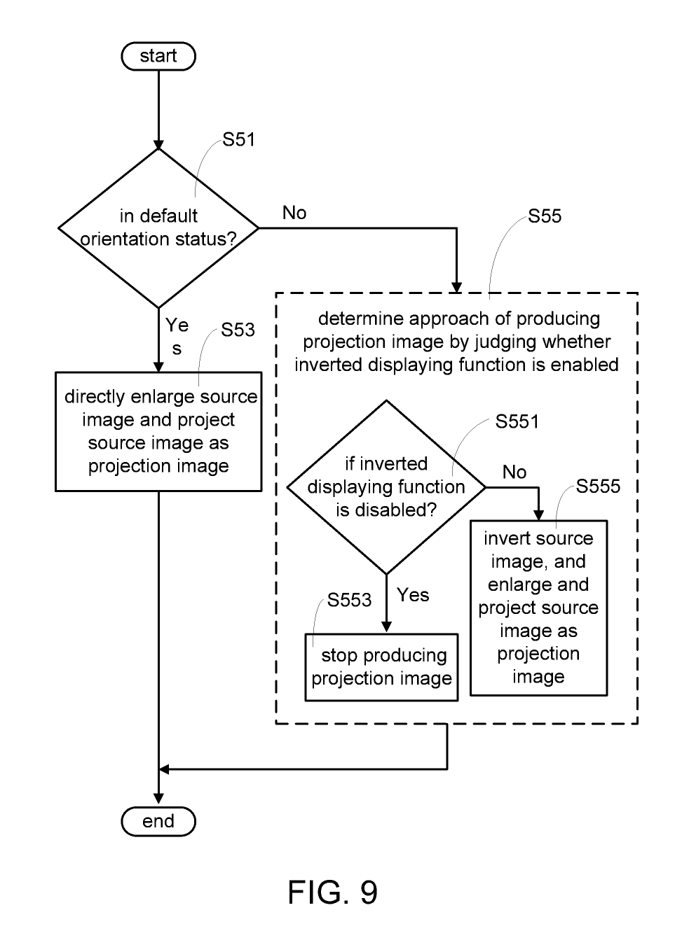

FIG. 8 is a flowchart illustrating a projecting method according to an embodiment of the present invention. Firstly, in the step S1, an orientation information of the portable electronic device is detected. Then, in the step S3, an orientation status of the portable electronic device 20 is realized according to the orientation information. Then, in the step S5, the source image is projected as a projection image according to the orientation status of the portable electronic device 20. Details of the step S5 will be illustrated with reference to FIG. 9.

FIG. 9 is a flowchart illustrating the step S5 of the projecting method according to the embodiment of the present invention. Firstly, the step S51 is performed to judge whether the portable electronic device 20 is in a default orientation status. If the judging condition of the step S51 is satisfied, the source image is enlarged and projected as the projection image directly (Step S53).

If the judging condition of the step S51 is not satisfied, it means that the portable electronic device 20 is in the inverted orientation status. Then, the approach of producing the projection image is determined according to whether an inverted displaying function is enabled or disabled (Step S55). The step S55 includes the following sub-steps. The sub-step S551 is performed to judge whether the inverted displaying function is disabled. If the judging condition of the sub-step S551 is satisfied, no projection image is produced (S553). Whereas, if the judging condition of the sub-step S551 is satisfied, the source image is rotated by 180 degrees and then enlarged and projected on the projection surface (S555).

From the above descriptions, the present invention provides a projecting method for a portable electronic device. In case that the portable electronic device in the inverted orientation status and the inverted displaying function is enabled, the projection image can be normally displayed. In case that the portable electronic device in the inverted orientation status and the inverted displaying function is disabled, no projection image is produced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable electronic device with a projecting function, comprising:
a posture sensor, for detecting an orientation information of the portable electronic device;
a projection lens, for projecting a source image as a projection image; and
a controller, electrically connected with the posture sensor and the projection lens, for judging an orientation status of the portable electronic device according to the orientation information, wherein an approach of producing the projection image is correspondingly adjusted according to the orientation status.

2. The portable electronic device as claimed in claim 1, wherein after an image beam is outputted from the projection lens, the image beam is projected as the projection image on a projection surface.

3. The portable electronic device as claimed in claim 1, wherein
if the controller judges that the portable electronic device is in a default orientation status according to the orientation information, the source image is enlarged and projected as the projection image; and
if the controller judges that the portable electronic device is in an inverted orientation status according to the orientation information, the approach of producing the projection image is determined by judging whether an inverted displaying function is enabled.

4. The portable electronic device as claimed in claim 3, wherein when the portable electronic device in the default orientation status is rotated by 180 degrees, the portable electronic device is changed to be in the inverted orientation status.

5. The portable electronic device as claimed in claim 3, wherein the inverted displaying function is selectively enabled according to settings of an application software.

6. The portable electronic device as claimed in claim 3, wherein when the portable electronic device is in the inverted orientation status and the inverted displaying function is disabled, the projection image is not produced.

7. The portable electronic device as claimed in claim 1, wherein when the portable electronic device is in the inverted orientation status and the inverted displaying function is enabled, the source image is inverted and then enlarged and projected as the projection image.

8. The portable electronic device as claimed in claim 1, wherein the posture sensor is a gyroscope.

9. A projecting method for a portable electronic device, comprising steps of:
detecting an orientation information of the portable electronic device;
judging an orientation status of the portable electronic device according to the orientation information; and
projecting a source image as a projection image, wherein an approach of producing the projection image is correspondingly adjusted according to the orientation status.

10. The projecting method as claimed in claim 9, wherein the step of projecting the source image as a projection image further comprises steps of:
if the controller judges that the portable electronic device is in a default orientation status, enlarging and projecting the source image as the projection image; and
if the controller judges that the portable electronic device is in an inverted orientation status, determining the approach of producing the projection image by judging whether an inverted displaying function is enabled.
